(19) United States
(12) Patent Application Publication
(10) Pub. No.: US 2010/0141628 A1
(43) Pub. Date: Jun. 10, 2010

(54) DISPLAY, DISPLAY PANEL, METHOD FOR INSPECTING DISPLAY PANEL AND METHOD FOR MANUFACTURING DISPLAY PANEL

(75) Inventor: Masahiro Shiratori, Saitama (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/593,546

(22) PCT Filed: Mar. 28, 2007
(86) PCT No.: PCT/JP2007/056646

§ 371 Date: Dec. 17, 2009

(51) Int. Cl. G09G 5/00; H01J 1/62; H01J 9/42; H01J 9/26

(52) U.S. Cl. 345/211; 313/504; 445/3; 445/25

(57) ABSTRACT

An organic electroluminescent device comprising a plurality of electrodes stacked on a substrate, at least one of the electrodes being transparent, an organic electroluminescent layer that is layered between the plurality of electrodes and emits light by an electric field generated between the plurality of electrodes by an applied voltage, and emission sealing layers that are members that seal the plurality of electrodes and the organic electroluminescent layer and emit light by light excitation, is provided.

### CROSS-REFERENCE TO RELATED APPLICATION

This is an application PCT/JP2007/56646, filed Mar. 28, 2007, which was not published under PCT article 21(2) in English.

### BACKGROUND OF THE INVENTION

1. Field of the Invention

The present invention relates to a display device, display panel, display panel inspection method, and display panel manufacturing method comprising an organic electroluminescent device wherein an organic electroluminescent layer emits light by an electric field generated in a plurality of electrodes.

2. Description of the Related Art

In recent years, display devices that employ a so-called organic electroluminescent device have been developed as the next generation display to replace the liquid crystal display. A display that employs such an electroluminescent device (hereinafter “organic EL display”) is capable of achieving high-brightness light emission even at a low voltage.

Such an organic EL display has attracted much attention as a self-luminous planar display device, and emits light with high light emission efficiency based on a simple device structure. Specifically, the organic electroluminescent device of the organic EL display is a device wherein holes and electrons respectively injected from a plurality of opposing electrodes are combined within a light-emitting layer that employs an organic substance, thereby generating an energy that excites a fluorescent substance within the light-emitting layer, causing the device to emit light.

In the organic electroluminescent devices of recent years, a sealing technique (generally referred to as “film sealing”) by which a sealing layer having moisture barrier and gas barrier characteristics is formed as a film on a substrate on which the aforementioned electrodes and organic electroluminescent layer are formed has been employed. The principle behind this sealing technique is to cover the EL substrate with a sealing layer having moisture barrier and gas barrier characteristics so as to achieve sealing capability, and then further increase this sealing capability by using a multi-layered structure.

At this time, however, a non-luminous region of the organic electroluminescent device referred to as a “dark spot” may increase in size, resulting in a defect. The main cause of such a dark spot is a pinhole that occurs during film formation. Moisture permeation then occurs from this point defect, enlarging the non-luminous spot of the organic electroluminescent device into a circular shape. Whether or not this circular-shaped non-luminous defect will further enlarge due to subsequent moisture permeation is determined by whether or not a defect exists in the sealing layer and the size of the defective area. In related art for reducing such dark spots and the like, methods of providing a buffer layer (planarization layer) that covers the defective area, etc., are known (refer to JP, A, 10-312883).

With such a sealing technique, it is possible to reduce the number of defects in the sealing layer of organic electroluminescent devices of the prior art. Nevertheless, in a case where a point defect that cannot be completely covered by a buffer layer exists, a great amount of time is generally required to recognize the spot as a large non-luminous defect of the display device prior to product shipment. Thus, in the inspection stage performed prior to shipment, the problem arises that defective organic electroluminescent device products cannot be completely sorted out.

The above-described problem is given as one example of the problems that are to be solved by the present invention.

### SUMMARY OF THE INVENTION

To solve the foregoing problem, the invention according to claim 1 is a display device comprising: a display panel having an organic electroluminescent device; and a driving circuit, the organic electroluminescent device including: a plurality of electrodes stacked on a substrate, one of the electrodes being transparent; an organic electroluminescent layer that is stacked between the plurality of electrodes and emits light by means of an electric field generated between the plurality of electrodes by an applied voltage; and an emission sealing layer that is a member configured to seal the plurality of electrodes and the organic electroluminescent layer and emits light by light excitation; and the driving circuit providing an applied voltage between the plurality of electrodes in accordance with inputted image data so as to drive each of the organic electroluminescent devices of the display panel.

To solve the foregoing problem, the invention according to claim 8 is a display panel comprising an organic electroluminescent device, the organic electroluminescent device including: a plurality of electrodes stacked on a substrate, at least one of the electrodes being transparent; an organic electroluminescent layer that is stacked between the plurality of electrodes and emits light by means of an electric field generated between the plurality of electrodes by an applied voltage; and an emission sealing layer that is a member configured to seal the substrate, the plurality of electrodes, and the organic electroluminescent layer, and emits light be light excitation.

To solve the foregoing problem, the invention according to claim 9 is a display panel inspection method comprising the steps of: a light irradiation step for irradiating light on an emission sealing layer of each organic electroluminescent device of a display panel, the display panel including the organic electroluminescent device, the organic electroluminescent having: a plurality of electrodes stacked on a substrate, one of the electrodes being transparent; an organic electroluminescent layer that is stacked between the plurality of electrodes and emits light by means of an electric field generated between the plurality of electrodes by an applied voltage; and the emission sealing layer that is a member configured to seal the plurality of electrodes and the organic electroluminescent layer and emits light by light excitation; and a defect inspection step for determining that a defect exists in the emission sealing layer in a case where a non-luminous spot is found on the emission sealing layer, and for determining that a defect does not exist in the emission sealing layer in a case where a non-luminous spot is not found on the emission sealing layer, in accordance with a light-emitting state of the emission sealing layer.

To solve the foregoing problem, the invention according to claim 10 is a display panel manufacturing method comprising the steps of: a first electrode formation step for stacking a transparent first electrode on a substrate; a light-emitting layer formation step for forming an organic electroluminescent layer that emits light by an electric field on the first electrode; a second electrode formation step for forming a second electrode on the organic electroluminescent layer; an emission sealing layer formation step for forming an emission sealing layer that is a sealing base material for sealing the first electrode, the organic electroluminescent layer, and the second electrode, and emits light by light excitation; and a light irradiation step for irradiating light on the emission sealing layer of each organic electroluminescent device of a display panel, the organic electroluminescent device comprising the substrate, the first electrode, the organic electroluminescent layer, the second electrode, and the emission sealing layer.

### BRIEF DESCRIPTION OF THE DRAWINGS

FIG. 1 is a front view illustrating an example of the outer appearance of the display device of embodiment 1.

FIG. 2 is a cross-sectional view illustrating a configuration example of the organic electroluminescent device arranged in the display panel of FIG. 1.

FIG. 3 is a cross-sectional view illustrating an example of the mode in which the organic electroluminescent device is manufactured.

FIG. 4 is a cross-sectional view illustrating an example of the mode in which the organic electroluminescent device is manufactured.

FIG. 5 is a cross-sectional view illustrating an example of the mode in which the organic electroluminescent device is manufactured.

FIG. 6 is a cross-sectional view illustrating an example of the mode in which the organic electroluminescent device is manufactured.

FIG. 7 is a cross-sectional view illustrating an example of the mode in which the organic electroluminescent device is manufactured.

FIG. 8 is a cross-sectional view illustrating an example of the mode in which the organic electroluminescent device is manufactured.

FIG. 9 is a cross-sectional view illustrating a configuration example of an organic electroluminescent device built into a display panel of the display device of embodiment 2.

FIG. 10 is a cross-sectional view illustrating an example of a defect detected in the inspection process.

FIG. 11 is a cross-sectional view illustrating an example of a defect detected in the inspection process.

FIG. 12 is a cross-sectional view illustrating an example of a defect detected in the inspection process.

FIG. 13 is a cross-sectional view illustrating an example of a defect detected in the inspection process.

### DETAILED DESCRIPTION OF THE PREFERRED EMBODIMENTS

The following describes an embodiment of the present invention with reference to accompanying drawings.

### Embodiment 1

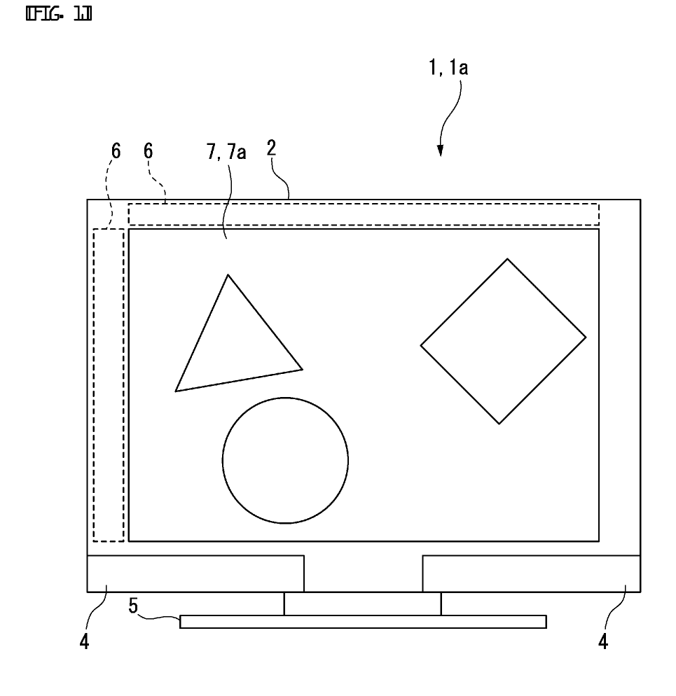

FIG. 1 is a front view illustrating an example of the outer appearance of a display device 1 comprising an organic electroluminescent device 3 of embodiment 1.

The display device 1 has a housing 2 and legs 5. The housing 2 is supported on an installation surface by the legs 5. This housing 2 visually comprises a display panel 7 and two speakers 4. The display panel 7 is provided at the center of the housing 2 and, at this center of the housing 2, has a function of displaying images based on image data inputted from an external source. The speakers 4 are respectively provided on the right side and left side underneath the housing 2.

The speakers 4 have a function of outputting sound in synchronization with the image displayed on the display panel 7. The housing 2 comprises a drive circuit 6 within its interior. This drive circuit 6 performs drive control for displaying images based on the aforementioned image data on the display panel 7.

The display panel 7 is a panel that employs a so-called organic electroluminescent device (organic EL device). The display panel 7 comprises a configuration wherein a large number of organic electroluminescent devices are arranged in a matrix shape. These organic electroluminescent devices arranged in a matrix shape are driven and controlled per pixel based on the control performed by the drive circuit 6.

FIG. 2 is a cross-sectional view illustrating a configuration example of the organic electroluminescent device 3 arranged in the display panel 7 of FIG. 1.

The organic electroluminescent device 3 is a bottom-emission type organic electroluminescent device, for example, with one device formed correspondingly for each color red, green, and blue, for example. Note, however, that this organic electroluminescent device 3 may be a top-emission type organic electroluminescent device as well. The organic electroluminescent device 3 comprises a structure wherein an anode 46 (transparent electrode), a light-emitting layer 49 (organic electroluminescent layer), and a cathode 52 (electrode) are stacked in the described order on a glass substrate 45 and then sealed by a sealing layer 8.

The anode 46 and the cathode 52 (electrodes) comprise a configuration in which the two are stacked on the glass substrate 45, with one being transparent. Further, the anode 46 and the cathode 52 are respectively made of a material such as ITO (Indium Tin Oxide) and Al. Furthermore, the organic electroluminescent device 3 may employ a structure wherein an electric charge and exciter diffusion layer for capturing an electric charge and exciter within the light-emitting layer 49 is layered. The organic electroluminescent device 3 shown in the figure corresponds to one pixel section.

The glass substrate 45 is formed by a transparent material. Note that the anode 46 may be made of the material IZO rather than the above-mentioned ITO. The anode 46 comprises a transparent electrode through which a light L emitted by the light-emitting layer 49 is transmitted, as described later. The anode 46 (one of the plurality of electrodes) is formed on the glass substrate 45 at large, along the glass substrate 45. This anode 46 has a function of supplying holes to the light-emitting layer 49 described later.

The light-emitting layer 49 is a light-emitting device that employs a so-called electroluminescence (EL) phenomenon. The light-emitting layer 49 is layered between the plurality of electrodes 46 and 52, and has the function of emitting light by an electric field generated between the plurality of electrodes 46 and 52 by an applied voltage. This light-emitting layer 49 outputs its own light L by utilizing a phenomenon in which light is emitted based on energy received from an external force using an electric field.

In a case where the organic electroluminescent device 3 is a bottom-emission type, as in the present embodiment, for example, the light-emitting layer 49 largely emits the light L (external light) downward. The light L thus emitted by the light-emitting layer 49 is not only removed to an external source of the organic electroluminescent device 3 as external light, but is also sometimes lost within the organic electroluminescent device 3.

The sealing layer 8 (emission sealing layer) is a member that seals the plurality of electrodes 46 and 52 and the light-emitting layer 49 (organic electroluminescent layer), and has a function of emitting light by light excitation. In this embodiment, this sealing layer 8 is referred to as the emission sealing layer 8. The emission sealing layer 8 is made by doping the emission center in a sealing base material that serves as the basis. Examples of the basis employed include SiOx, SiNx, AlOx, or AlNx (where X indicates a positive integer), for example. This basis preferably comprises gas barrier characteristics, for example.

The emission center is, for example, a rare earth element or transition metal. Specifically, the material that can be utilized at the emission center includes, for example, a rare earth element such as Tb (green emission), Eu (red emission), or Er (green or red emission), or a transition metal such as Mn (orange emission) or Cr (red emission). The thickness of the emission sealing layer 8 is at least, for example, greater than or equal to 10 nm and less than or equal to 100 μm, preferably greater than or equal to 100 nm and less than or equal to 10 μm, for example.

### Operation Example of the Organic Electroluminescent Device 3

The organic electroluminescent device 3 and the display device 1 into which the organic electroluminescent device 3 is built thus comprise the above-described configuration, and an example of the operation of the organic electroluminescent device 3 and the display device 1 into which the organic electroluminescent device 3 is built will now be described.

In the display device 1 illustrated in FIG. 1, a large number of organic electroluminescent devices 3 is arranged in a matrix shape in the display panel 7 thereof, and the large number of organic electroluminescent devices 3 operates as described below based on the control performed by the drive circuit 6.

First, the drive circuit 6 drives each of the organic electroluminescent devices 3 based on inputted imaged data so as to display an image based on the image data on the display panel 7. Then, in each of the organic electroluminescent devices 3, this drive circuit 6 applies DC voltage from a predetermined power supply (not shown) between the anode 46 and the cathode 52 illustrated in FIG. 2.

When DC voltage is thus applied to the anode 46 and the cathode 52, the anode 46 discharges holes. The holes discharged from the anode 46 arrive at the light-emitting layer 49. In this manner, the light-emitting layer 49 is capable of receiving holes from the anode 46. On the other hand, the cathode 52 injects electrons into the light-emitting layer 49. In this manner, the light-emitting layer 49 is capable of receiving electrons discharged from the cathode 52.

The light-emitting layer 49 operates as described below based on the holes and electrons thus injected. The injected holes and electrons are recombined inside the light-emitting layer 49, and there are in excited state, which is in an unstable, high-energy state. The light-emitting layer 49 then promptly returns to its original ground state, which is a stable, low-energy state. At this time, the light-emitting layer 49 emits the light L based on the difference in energy between the excited state and the ground state.

With this arrangement, the display device 1 illustrated in FIG. 1 emits the light L from the pixels corresponding to each of the organic electroluminescent devices 3 based on the control performed by the drive circuit 6, making it possible to display a predetermined image on the display panel 7. At this time, the display device 1 is capable of outputting sound from the speakers 4 in synchronization with the display of this image.

### Display Panel Manufacturing Method

With the operation example of the organic electroluminescent device 3 and the display device 1 as described above, an example of the manufacturing method of the organic electroluminescent device 3 arranged in the display panel 1 will now be described with reference to FIG. 2. Note that the manufacturing method of the display panel 7 includes the inspection method of the organic electroluminescent device 3.

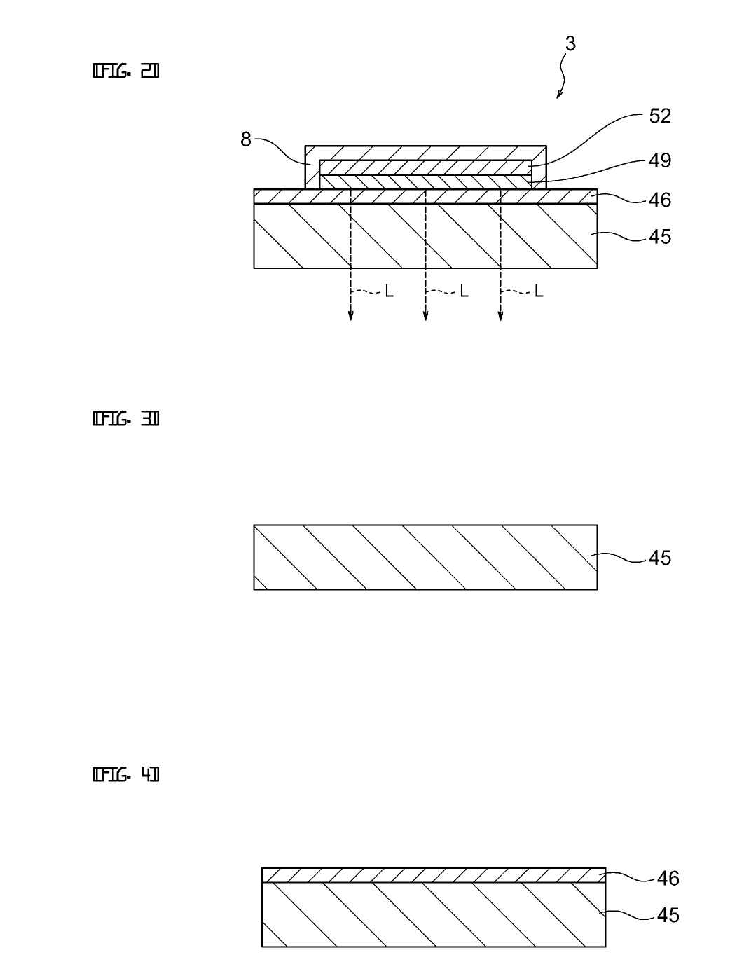

FIG. 3 to FIG. 8 are each cross-sectional views illustrating an example of the mode in which the organic electroluminescent device 3 of the display panel 7 is manufactured according to the above-described manufacturing method.

First, the glass substrate 45 is prepared as illustrated in FIG. 3, and the transparent anode 46 is formed as a film on top of this glass substrate 45 as illustrated in FIG. 4 (first electrode formation step). The light-emitting layer 49 is then formed on top of the anode 46 thus formed, at a position where the organic electroluminescent device 3 is to be formed, as illustrated in FIG. 5 (light-emitting layer formation step).

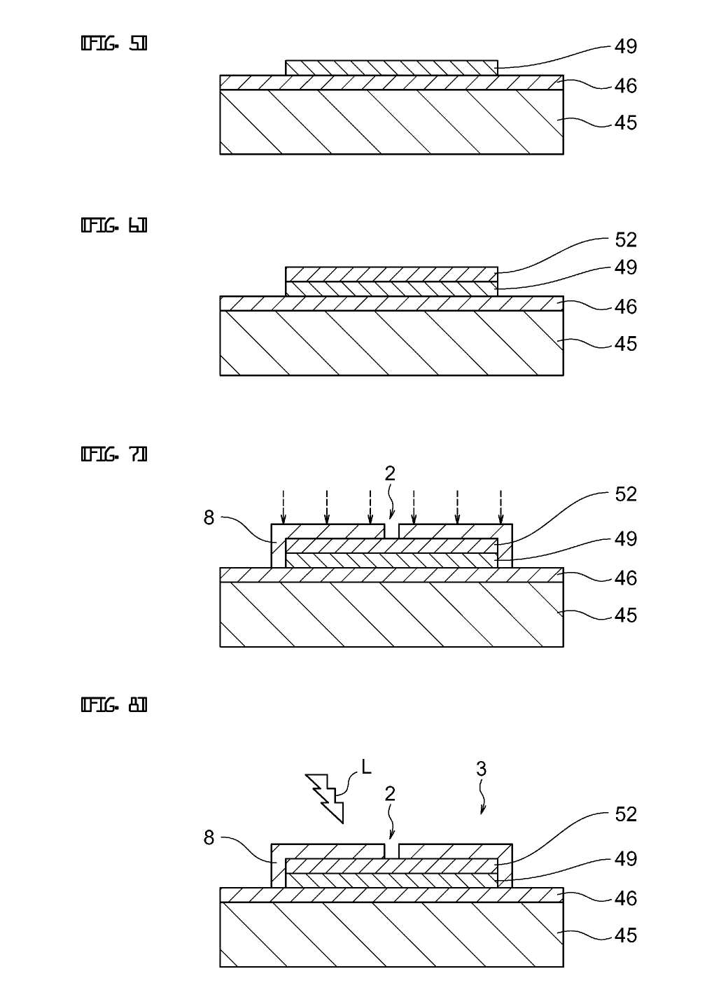

Furthermore, as illustrated in FIG. 6, the cathode 52 is formed as a film on top of this light-emitting layer 49 (second electrode formation step). A sealing base material is then formed on top of the cathode 52 so as to cover not only the cathode 52 but the light-emitting layer 49 as well as the cathode 52 (part of the emission sealing layer formation step). This sealing base material may be formed by a vapor deposition method based on CVD (Chemical Vapor Deposition) or sputtering, for example, or may be formed using an evaporation method based on vacuum evaporation, for example. In this manner, the organic electroluminescent device 3 is thus manufactured.

In the organic electroluminescent device 3 thus formed, the emission center is doped with a sealing base material that is to serve as the basis of the emission sealing layer 8, as illustrated in FIG. 7 (part of the emission sealing layer formation step). In a case where the film is formed by sputtering, the target material used is a metal such as Al that contains Mn as the raw material of the light emission center at 5 wt % (percent by weight), for example. At the time of formation of the emission sealing layer 8, a 300 nm AlN:Mn layer is formed by reactive sputtering with N₂ used as the reactive gas.

While the emission sealing layer 8 is thus formed, the defect 2 such as illustrated in the figure sometimes occurs in the emission sealing layer 8 when the device is thus sealed by the emission sealing layer 8. This defect 2 is very small, for example, and cannot be visually recognized as is. In this embodiment, the sealed stated achieved by the emission sealing layer 8 is then inspected as described below.

### Inspection Process

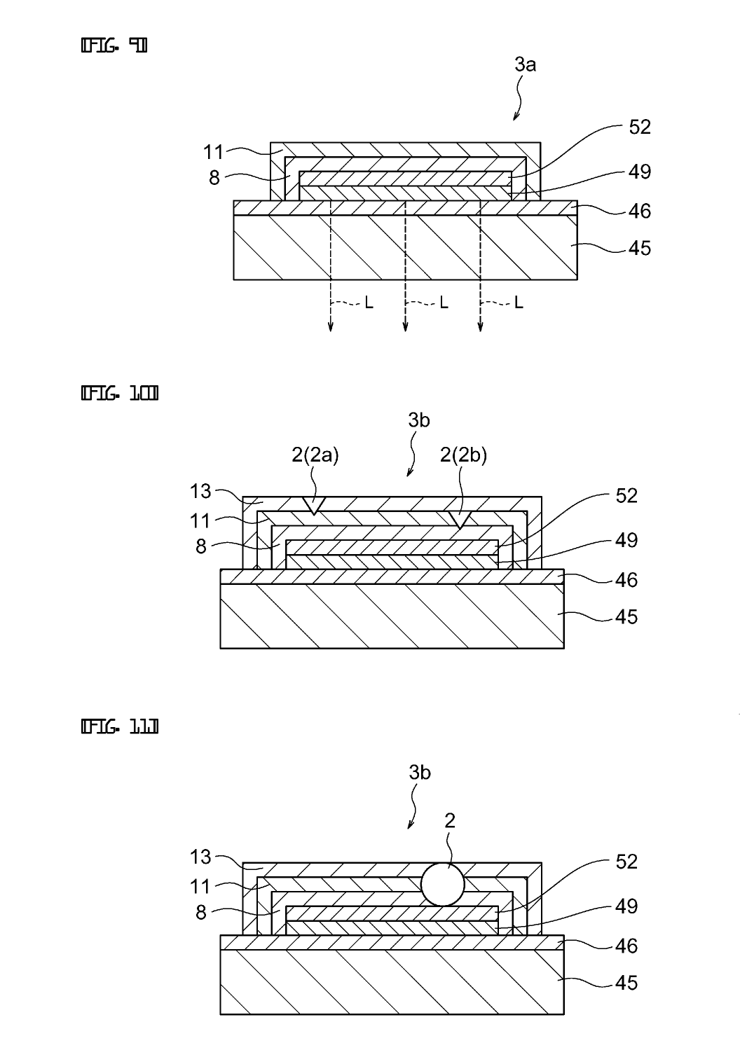

First, the organic electroluminescent device 3 irradiates excitation light onto the emission sealing layer 8 as illustrated in FIG. 8. The emission sealing layer 8 absorbs the excitation light (ultraviolet light L from an Hg lamp, for example) thus irradiated, and the excitation light causes the entire unit to emit light. Specifically, this inspection method makes it possible to confirm, for example, an orange light emission having a peak wavelength of 580 nm emitted from the emission center, which is Mn. Then, in a certain display device 1, the inspection method makes it possible to detect among the pixels (the organic electroluminescent device 3) of the display panel 7 thereof, a non-luminous spot, that is, the defect 2 of the emission sealing layer 8, having an approximate 3 μm diameter.

With the emission sealing layer 8, light excitation does not occur in the area of the defect 2, making it possible to visually recognize only the area of the defect 2 of the emission sealing layer 8 as a dark spot (non-luminous spot). That is, at this defect 2, the emission sealing layer 8 (gas barrier film) does not emit light, enabling recognition of the point defect. Furthermore, in a case where such the defect 2 having an approximate diameter of 3 μm exists, the non-luminous region (equivalent to the so-called dark spot) of the organic electroluminescent device 3 increases in size within several hundred seconds at room temperature to the extent that it is visually recognizable, making it possible to remove that display device 1 as a defective product.

Thus, since such the defect 2 is visually recognizable as a non-luminous spot, according to this inspection process (inspection method), it is possible to quickly and easily recognize the presence of an (expanding) spot-shaped defect 2 that enlarges with the passage of time at ambient temperature, prior to shipment of the display device 1 comprising the display panel 7, for example. This makes it possible to prevent outflow to the market of the display device 1 (defective product) that employs the display panel 7 comprising a built-in organic electroluminescent device 3 having the defect 2.

In this embodiment, the emission sealing layer 8 that contains material that emits light by light excitation is thus employed as the sealing member, enabling detection of the defect 2 as a non-luminous spot or abnormal light-emitting spot by excitation irradiation of ultraviolet light or the like from the emission sealing layer 8.

Here, the emission sealing layer 8 is a layer that functions as a gas barrier. In a case where the defect 2 having a certain size, such as an approximate diameter of 1μm or greater, for example, exists in this emission sealing layer 8, the dark spot, which is a non-luminous spot, enlarges in the display panel 7 of that display device 1. Accordingly, in this embodiment, the display device 1 comprising a built-in display panel 7 where the defect 2 having an approximate diameter of 1 μm or greater has occurred is removed as a defective product, thereby preventing outflow of such a defective product to the market. With this, in this embodiment, it is possible to not remove but rather ship to the market in a phased manner any of the display devices 1 comprising the built-in display panel 7 having the defect 2 of a diameter less than that above.

The display device 1 of the above embodiment comprises the display panel 7; and the drive circuit 6, the organic electroluminescent device 3 including: the plurality of electrodes 46 and 52 stacked on the substrate 45 (glass substrate), one of the electrodes 46, 52 being transparent; the organic electroluminescent layer (light-emitting layer) 49 that is layered between the plurality of electrodes 46 and 52 and emits light by means of an electric field generated between the plurality of electrodes 46 and 52 by an applied voltage; and the emission sealing layer 8 that is a member configured to seal the plurality of electrodes 46 and 52 and the organic electroluminescent layer 49 and emits light be light excitation; and the drive circuit 6 providing an applied voltage between the plurality of electrodes 46 and 52 in accordance with inputted image data so as to drive each of the organic electroluminescent devices 3 of the display panel 7.

The display panel 7 of the above embodiment comprises the organic electroluminescent device 3, the organic electroluminescent device 3 including: the plurality of electrodes 46 and 52 stacked on the substrate 45 (glass substrate), one of the plurality of electrodes 46, 52 being transparent, the organic electroluminescent layer (light-emitting layer) 49 that is layered between the plurality of electrodes and emits light by means of an electrical field generated between the plurality of electrodes by an applied voltage, and the emission sealing layer 8 that is a member that seals the plurality of electrodes 46 and 52 and the organic electroluminescent layer 49 and emits light by light excitation.

According to such a configuration, when light is irradiated on the emission sealing layer 8, the emission sealing layer 8 absorbs this light and emits light across its entirety by light excitation. In a case where the defect 2 has occurred in the emission sealing layer 8, only the area of that defect 2 does not emit light, making it easy to visually recognize that area as a non-luminous spot (dark spot). With this arrangement, the emission sealing layer 8 can be easily visually inspected for the defect 2 using the simple method of irradiating light on the emission sealing layer 8.

To identify prior to shipment whether the defect 2 (dark spot) is a point defect having expandability, any known general analytical method may be used, such as surface shape analysis by a white light interference microscope or AFM. While these methods make it possible to measure the convexoconcave shape of the emission sealing layer 8 and detect the size of the defect 2 on the overall surface of the display panel 7, difficulties arise when an attempt is made to detect the defect 2 having an extremely small size on the overall surface of the display panel 7. Nevertheless, according to this embodiment, it is possible to easily detect the defect 2 having an extremely small size. Further, when the surface area of the display panel 7 (organic EL panel) is wide, such analysis related to the presence of the defect 2 requires much time when three-dimensional analysis is employed, and any attempt to ascertain the presence of the defect 2 in the emission sealing layer 8 by height information only is confronted with difficulties. According to this embodiment, however, the defect 2 is easily detectable within a short period of time, and it is possible to identify the presence of the defect 2 in the emission sealing layer 8.

In the display device 1 and the display panel 7 of the above embodiment, the emission sealing layer 8 is designed so that the emission center is doped with a sealing base material that serves as the basis in the above configuration.

According to such a configuration, the emission sealing layer 8 can be formed while maintaining the air tightness retention (gas barrier) characteristics of the organic electroluminescent layer 49 (light-emitting layer), etc., that exists therein.

In the display device 1 and the display panel 7 of the above embodiment, the emission center is a rare earth element or transition metal in the above configuration.

According to such a configuration, a rear earth element or transition metal is used as the emission center, making it possible to easily form the emission sealing layer 8.

In the display device 1 and the display panel 7 of the above embodiment, the emission sealing layer 8 is formed by a vapor deposition method in the above configuration.

With this arrangement, the emission sealing layer 8 can be simply formed using a general film formation method.

In the display device 1 and the display panel 7 of the above embodiment, the emission sealing layer 8 is formed by an evaporation method in the above configuration.

With this arrangement, in a case where the emission sealing layer 8 is formed using an evaporation method such as vacuum evaporation, the emission sealing layer 8 can be formed without making the organic electroluminescent layer 49, which is susceptible to moisture, contact moisture, thereby preventing damage to the organic electroluminescent layer 49.

The inspection method of the display panel 7 of the above embodiment comprises the steps of: a light irradiating step for irradiating light on the emission sealing layer 8 of each of the organic electroluminescent devices 3 of the display panel 7, the display panel 7 including the organic electroluminescent device 3, the organic electroluminescent device 3 having: the plurality of electrodes 46 and 52 stacked on the substrate 45 (glass substrate), one of the electrodes 46, 52 being transparent, the organic electroluminescent layer 49 (light-emitting layer) that is layered between the plurality of electrodes 46 and 52 and emits light by means of an electric field generated between the plurality of electrodes 46 and 52 by an applied voltage, and the emission sealing layer 8 that is a member configured to seal the plurality of electrodes 46 and 52 and the organic electroluminescent layer 49 and emits light by light excitation; and a defect inspection step for determining that a defect exists in the emission sealing layer 8 in a case where a non-luminous spot is found in the emission sealing layer 8 and for determining that a defect does not exist in the emission sealing layer 8 in a case where a non-luminous spot is not found in the emission sealing layer 8, in accordance with a light-emitting state of the emission sealing layer 8.

With this arrangement, when light is irradiated on the emission sealing layer 8, the emission sealing layer 8 absorbs this light and emits light across its entirety by light excitation. In a case where the defect 2 has occurred in that emission sealing layer 8, only the area of that defect 2 does not emit light, making it easy to visually recognize that area as a non-luminous spot (dark spot). With this arrangement, the emission sealing layer 8 can be easily visually inspected for the defect 2 using the simple method of irradiating light on the emission sealing layer 8.

According to this embodiment, compared to a case where surface shape analysis by a white light interference microscope or AFM such as described above is employed, it is possible to easily detect the defect 2 having an extremely small size as described above. Further, while such analysis related to the presence of the defect 2 is confronted with difficulties for reasons such as described above when an attempt is made to determine the presence of the defect 2 in the emission sealing layer 8 by height information only, according to this embodiment, it is possible to easily detect the defect 2 within a short period of time and identify whether or not the defect 2 exists in the emission sealing layer 8.

The manufacturing method of the display device 1 of the above embodiment comprises the steps of: a first electrode formation step for stacking the first transparent electrode 46 on the substrate 45, a light-emitting layer formation step for forming on the first electrode 46 the organic electroluminescent layer 49 (light-emitting layer) that emits light by an electric field generated between the plurality of electrodes 46 and 52 by applied voltage, a second electrode formation step for forming the second electrode 52 on the organic electroluminescent layer 49, an emission sealing layer formation step for forming the emission sealing layer 8 that is a sealing member for sealing the substrate 45, the first electrode 46, the organic electroluminescent layer 49, and the second electrode 52 and emits light by light excitation, and a light irradiation step for irradiating light on the emission sealing layer 8 of each of the organic electroluminescent devices 3 of the display panel 7, the organic electroluminescent device 3 comprising the substrate 45, the first electrode 46, the organic electroluminescent layer 49, the second electrode 52, and the emission sealing layer 8.

When the display device 1 manufactured according to such a manufacturing method irradiates light on the emission sealing layer 8, the emission sealing layer 8 absorbs this light, causing light to be emitted across its entirety by light excitation. In a case where the defect 2 has occurred in that emission sealing layer 8, only the area of that defect 2 does not emit light, making it easy to visually recognize that area as a non-luminous spot (dark spot). With this arrangement, the emission sealing layer 8 can be easily visually inspected for the defect 2 using the simple method of irradiating light on the emission sealing layer 8.

According to this embodiment, compared to a case where surface shape analysis by a white light interference microscope or AFM such as described above is employed, it is possible to easily detect the defect 2 having an extremely small size as described above. Further, while such analysis related to the presence of the defect 2 is confronted with difficulties for reasons such as described above when an attempt is made to determine the presence of the defect 2 in the emission sealing layer 8 by height information only, according to this embodiment, it is possible to easily detect the defect 2 within a short period of time and identify whether or not the defect 2 exists in the emission sealing layer 8.

### Embodiment 2

FIG. 9 is a cross-sectional view illustrating a configuration example of an organic electroluminescent device 3a built into a display device 1a of embodiment 2.

This organic electroluminescent device 3a involves substantially the same configuration, substantially the same operation, and substantially the same manufacturing method as those of embodiment 1. The same reference numerals as the numerals in FIG. 1 to FIG. 8 will therefore be employed for identical components, identical operations, and identical manufacturing methods and descriptions thereof will be omitted. The following description will focus on the unique points of this embodiment.

In the organic electroluminescent device 3a of embodiment 2, unlike embodiment 1, the emission sealing layer 8 comprises a multi-layered configuration rather than a single-layered configuration as described above. Specifically, in embodiment 2, as illustrated in FIG. 9, a separate emission sealing layer 11 is formed so as to cover the above-described emission sealing layer 8.

In embodiment 2, each of the plurality of emission sealing layers 8 and 11 is made of a light-emitting material that emits light at different wavelengths, for example. The emission sealing layer 11, similar to the emission sealing layer 8 of embodiment 1, may be formed by a vapor deposition method such as CVD or sputtering, or may be formed by an evaporation method such as vacuum evaporation.

### Inspection Process

FIG. 10 to FIG. 13 are each cross-sectional views illustrated an example of the defect 2 detected in the inspection process. In FIG. 10 to FIG. 13 is illustrated an example of an organic electroluminescent device 3b having a configuration wherein the organic electroluminescent device 3a is further sealed by another emission sealing layer 13.

### Pin-Hole Shaped Defect

In a case where the defect 2 is a film pin-hole that occurred during formation of the film in the manufacturing process as illustrated in FIG. 10, the defect 2 is detected as follows. That is, in the organic electroluminescent device 3b, the emission sealing layers 8, 11, and 13 each emit red, green, and blue light, respectively, from light excitation by ultraviolet light irradiated during the inspection process. Note that the emission sealing layers 11 and 13 are each transparent or semi-transparent members. That is, the emission sealing layers 11 and 13 transmit light emitted by the emission sealing layer 8, and the emission sealing layer 11 transmits light emitted by the emission sealing layer 13.

Then, in the organic luminescent device 3b, it is possible to detect a defect 2a in the emission sealing layer 13 since it is visually possible to recognize a non-luminous spot within the red light, and to detect a defect 2b in the emission sealing layer 11 since it is visually possible to recognize a non-luminous spot within the green light.

### Contamination Defect

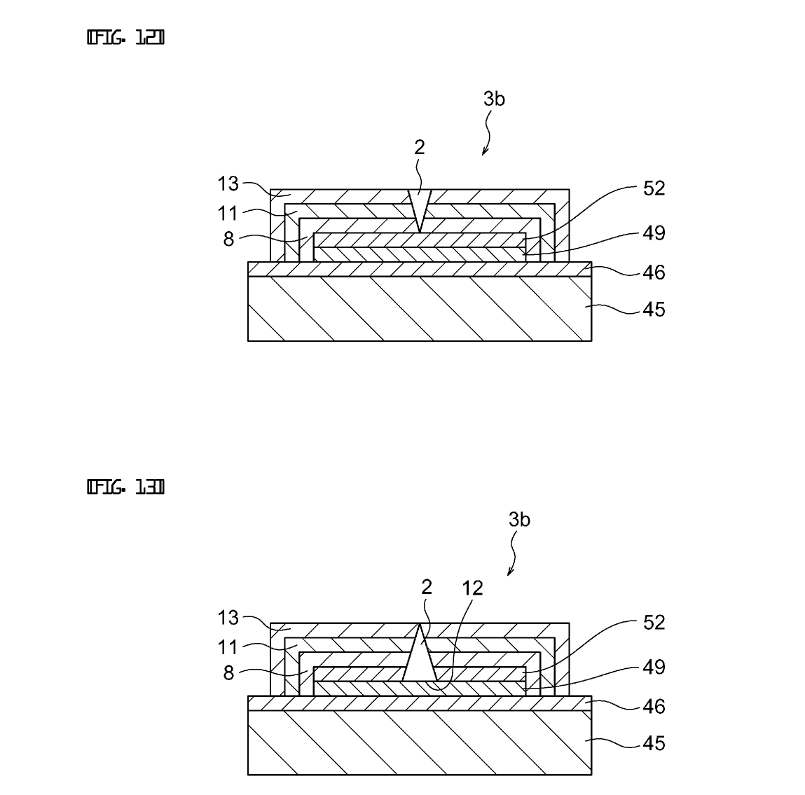

In a case where the defect 2 is mainly caused by foreign matter mixed into the product during the manufacturing process as illustrated in FIG. 11, the defect 2 is detected as follows. That is, in the organic electroluminescent device 3b, the emission sealing layers 8, 11, and 13 each emit red, green, and blue light, respectively, as a result of light excitation by ultraviolet light irradiated during the inspection process in the same manner as described above.

Then, in this organic electroluminescent device 3b, it is possible to visually recognize a somewhat small non-luminous spot within the red light in a specific section, a somewhat large non-luminous spot within the green light in the same location, and a somewhat small non-luminous spot within the blue light in the same location. Thus, in this organic electroluminescent device 3b, the large sphere-shaped defect 2 that extends across the emission sealing layers 8, 11, and 13 is detected.

### Manufacturing Process Defects

In a case where the defect 2 is the result of damage caused by contact with the glass substrate 45 during the manufacturing process as illustrated in FIG. 12, the defect 2 is detected as follows. That is, in the organic electroluminescent device 3b, the emission sealing layers 8, 11, and 13 each emit red, green, and blue light, respectively, as a result of light excitation by ultraviolet light irradiated during the inspection process in the same manner as described above.

Then, in the organic electroluminescent device 3b, it is possible to visually recognize a large non-luminous spot within the red light in a specific section, a somewhat large non-luminous spot within the green light in the same location, and a somewhat small non-luminous spot within the blue light at the same location. Thus, in the organic electroluminescent device 3b, the inverted triangle-shaped defect 2 that extends across the emission sealing layers 8, 11, and 13 is detected.

### Defects Due to Local Short Circuit During Operation

In a case where the defect 2 occurs as a result of a local short circuit during operation of the organic electroluminescent device 3a as illustrated in FIG. 13, when a short-circuit unit 12 is damaged, simultaneously causing damage in the emission sealing layer 8 due to physical peel force, the defect 2 is detected as follows. That is, in the organic electroluminescent device 3b, the emission sealing layers 8, 11, and 13 each emit red, green, and blue light, respectively, as a result of light excitation by ultraviolet light irradiated during the inspection process in the same manner as described above.

Then, in the organic electroluminescent device 3b, it is possible to visually recognize a small non-luminous spot within the red light in a specific section, a somewhat large non-luminous spot within the green light in the same location, and a large non-luminous spot within the blue light in the same location. Then, in the organic electroluminescent device 3b, the triangle-shaped defect 2 that extends across the emission sealing layers 8, 11, and 13 is detected.

In the organic electroluminescent device 3b, in a case where the defect 2, such as described above, occurs in the emission sealing layers 8, 11, and 13, the non-luminous region of the defect 2 during initial operation is small, but then expands as the cathode 52 deteriorates due to the subsequent moisture permeation when the defect 2 is not detected during the above inspection process.

Thus, according to embodiment 2, even in such cases, it is possible to prevent the organic electroluminescent device 3b having the defect 2 from being shipped as a product, or prevent the organic electroluminescent device 3b from being shipped as a product in accordance with the size and/or the type of the defect 2.

In the organic electroluminescent device 3a of the above embodiment, in addition to the configuration of the organic electroluminescent device 3 of embodiment 1, the emission sealing layer 8 is further stacked in multiple layers.

According to such a configuration, it is possible to determine whether or not the defect 2 exists per emission sealing layer 8 and 11. Further, as necessary, it is also possible to determine whether or not the defect 2 is problematic in terms of actual use, based on different determination criteria. This makes it possible to improve the production yield in comparison to a case where a determination is conducted to see whether or not the defect 2 simply exists.

In the organic electroluminescent device 3a of the above embodiment, in addition to the above configuration, further, each of the plurality of emission sealing layers 8 are made of a light-emitting material that emits light at a wavelength different from each other.

With such a configuration, it is possible to easily visually recognize which of the plurality of emission sealing layers 8 and 11 has a defect.

Note that this embodiment is not limited to the above, and various modifications are possible. In the following, details of such modifications will be described one by one.

While the above embodiments have described illustrative scenarios in which the organic electroluminescent devices 3 and 3a each comprise the light-emitting layer 49 between the anode 46 and the cathode 52, the present invention is not limited thereto, allowing the following as well.

That is, in the organic electroluminescent devices 3 and 3a, a mode where a hole injection layer 47 and a hole transport layer 48 are each provided between the anode 46 and the light-emitting layer 49, as well as a mode where an electron transport layer 50 and an electron injection layer 51 are provided between the light-emitting layer 49 and the cathode 52 are allowed. The material used for the hole injection layer 47, the hole transport layer 48, the electron transport layer 50, and the electron injection layer 51 may be CuPc, NPB, Alq₃, and LiF, respectively.

The hole injection layer 47 is stacked so that the holes are readily removable from the anode 46. The hole transport layer 48 has a function of transporting the holes removed from the anode 46 by the hole injection layer 47 to the light-emitting layer 49. The hole injection layer 47 is mainly stacked on the anode 46. The hole transport layer 48 is stacked on the hole injection layer 47.

The electron transport layer is stacked on the light-emitting layer 49. Furthermore, the electron injection layer 51 is stacked on the electron transport layer 50. The cathode 52 is formed on the electron injection layer 51. Of these, the electron injection layer 51 has the function of readily removing the electrons from the cathode 52. Additionally, the electron transport layer 50 has the function of efficiently transporting the electrons removed from the cathode 52 by the electron injection layer 51 to the light-emitting layer 49.

The sealing technique applied in the above embodiments may be an organic memory, sensor, or solar cell sealing technique for both the organic electroluminescent devices 3 and 3a. Further, in the above embodiments, various modes may be used for the configuration of sections other than the sections touched upon in the descriptions above. While the above embodiments have described illustrative scenarios in which the glass substrate 45 is used as the substrate, the present invention is not limited thereto, allowing use of a variety of materials. Further, in the above embodiments, the driving method of the display device 1 is not particularly limited.

Additionally, in the above embodiments, the excitation light irradiated to detect the defect 2 in the inspection process is not limited to ultraviolet light, allowing use of various wavelengths. Specifically, as the excitation light in the above embodiments, an excitation wavelength having the highest light emission efficiency is preferred. Furthermore, as the excitation light in the above embodiments, use of an excitation light having a long wavelength that minimizes damage to the organic electroluminescent device 3, etc., is preferred.

1-10. (canceled)

11. A display device comprising:
a display panel having an organic electroluminescent device; and
a driving circuit,
said organic electroluminescent device including:
a plurality of electrodes stacked on a substrate, one of said electrodes being transparent;
an organic electroluminescent layer that is stacked between said plurality of electrodes and emits light by means of an electric field generated between said plurality of electrodes by an applied voltage; and
an emission sealing layer that is a member configured to seal said plurality of electrodes and said organic electroluminescent layer and emits light by light excitation; and
said driving circuit providing an applied voltage between said plurality of electrodes in accordance with inputted image data so as to drive each of said organic electroluminescent devices of said display panel.

12. The display device according to claim 11, wherein:
said emission sealing layer is made by doping an emission center in a sealing base material that serves as a basis.

13. The display device according to claim 12, wherein:
said emission center is a rare earth element or a transition metal.

14. The display device according to claim 11, wherein:
said emission sealing layer is stacked to form multiple layers.

15. The display device according to claim 14, wherein:
each of the plurality of said emission sealing layers is made of a light-emitting material that emits light at a wavelength different with each other.

16. The display device according to claim 11, wherein:
said emission sealing layer is formed by a vapor deposition method.

17. The display device according to claim 11, wherein:
said emission sealing layer is formed by an evaporation method.

18. A display panel comprising an organic electroluminescent device,
said organic electroluminescent device including:
a plurality of electrodes stacked on a substrate, at least one of said electrodes being transparent;
an organic electroluminescent layer that is stacked between said plurality of electrodes and emits light by means of an electric field generated between said plurality of electrodes by an applied voltage; and
an emission sealing layer that is a member configured to seal said substrate, said plurality of electrodes, and said organic electroluminescent layer, and emits light be light excitation.

19. A display panel inspection method comprising the steps of:
a light irradiation step for irradiating light on an emission sealing layer of each organic electroluminescent device of a display panel, said display panel including said organic electroluminescent device, said organic electroluminescent having: a plurality of electrodes stacked on a substrate, one of said electrodes being transparent; an organic electroluminescent layer that is stacked between said plurality of electrodes and emits light by means of an electric field generated between said plurality of electrodes by an applied voltage; and said emission sealing layer that is a member configured to seal said plurality of electrodes and said organic electroluminescent layer and emits light by light excitation; and
a defect inspection step for determining that a defect exists in said emission sealing layer in a case where a non-luminous spot is found on said emission sealing layer, and for determining that a defect does not exist in said emission sealing layer in a case where a non-luminous spot is not found on said emission sealing layer, in accordance with a light-emitting state of said emission sealing layer.

20. A display panel manufacturing method comprising the steps of:
a first electrode formation step for stacking a transparent first electrode on a substrate;
a light-emitting layer formation step for forming an organic electroluminescent layer that emits light by an electric field on said first electrode;
a second electrode formation step for forming a second electrode on said organic electroluminescent layer;
an emission sealing layer formation step for forming an emission sealing layer that is a sealing base material for sealing said first electrode, said organic electroluminescent layer, and said second electrode, and emits light by light excitation; and
a light irradiation step for irradiating light on said emission sealing layer of each organic electroluminescent device of a display panel, said organic electroluminescent device comprising said substrate, said first electrode, said organic electroluminescent layer, said second electrode, and said emission sealing layer.

21. The display device according to claim 12, wherein:
said emission sealing layer is stacked to form multiple layers.

22. The display device according to claim 13, wherein:
said emission sealing layer is stacked to form multiple layers.
